(19) United States
(12) Patent Application Publication
(10) Pub. No.: US 2005/0206135 A1
(43) Pub. Date: Sep. 22, 2005

(54) Curtain airbag handling device

(76) Inventors: James E. Nelson, Ogden, UT (US); Kurt Gammill, Layton, UT (US)

Correspondence Address: Sally J. Brown;Autoliv ASP, Inc., 3350 Airport Road, Ogden, UT, 84405, US

(21) Appl. No.: 11/114,958

(22) Filed: Apr. 26, 2005

Related U.S. Application Data
(63) Continuation-in-part of application No. 10/694,322, filed on Oct. 27, 2003.

(51) Int. Cl. B60R 21/16

(52) U.S. Cl. 280/728.2; 280/730.2

(57) ABSTRACT

An airbag handling device is disclosed. The handling device may be located adjacent mounting locations of an inflatable curtain airbag. The handling device may be a stiffening member that has a stiffness greater than that of the inflatable curtain. The handling device may also be an inflatable chamber that is inflated separately from the cushioning chamber of the inflatable curtain. The handling device may help prevent twisting of the inflatable curtain between mounting locations and aid in positioning the inflatable curtain during handling or installation into a vehicle.

### RELATED APPLICATIONS

This application claims the benefit of U.S. patent application Ser. No. 10/694,322, filed Oct. 27, 2003 and entitled TWIST PREVENTION APPARATUS AND METHOD FOR AN INFLATABLE AIRBAG CURTAIN, which is incorporated herein by reference.

### TECHNICAL FIELD

The present invention relates generally to the field of automotive protective systems. More specifically, the present invention relates to handling devices for inflatable airbag curtain assemblies that prevent twisting of the inflatable curtain during manufacturing, handling, shipping, and installation into a vehicle.

### BRIEF DESCRIPTION OF THE DRAWINGS

The present embodiments will become more fully apparent from the following description and appended claims, taken in conjunction with the accompanying drawings. Understanding that the accompanying drawings depict only typical embodiments, and are, therefore, not to be considered to be limiting of the invention's scope, the embodiments will be described and explained with specificity and detail in reference to the accompanying drawings in which:

FIG. 1A is a side elevation view of an undeployed inflatable curtain airbag assembly coupled to a handling device;

FIG. 1B is a side elevation view of the undeployed inflatable curtain airbag assembly and handling device of FIG. 1A in a compacted configuration;

FIG. 2A is a side elevation view of an undeployed inflatable curtain airbag assembly coupled to an alternative embodiment of a handling device;

FIG. 2B is a side elevation view of the undeployed inflatable curtain airbag assembly and handling device of FIG. 2A in a folded configuration;

FIG. 3 is a partially cut-away perspective view of a handling device coupled to an inflatable curtain airbag;

FIG. 4A is a cross-sectional side elevation view of a handling device coupled to an inflatable curtain airbag through a releasable fastener;

FIG. 4B is a cross-sectional side elevation view of a handling device coupled to an inflatable curtain airbag through an alternative embodiment of a releasable fastener;

FIG. 5 is a partially cut-away perspective view of an alternative embodiment of a handling device slidably coupled to a mounting location of an inflatable curtain airbag; and

FIG. 6 is a partially cut-away side elevation view of a deployed inflatable curtain airbag including a separately inflatable twist prevention chamber.

### DETAILED DESCRIPTION OF PREFERRED EMBODIMENTS

It will be readily understood that the components of the embodiments as generally described and illustrated in the Figures herein could be arranged and designed in a wide variety of different configurations. Thus, the following more detailed description of various embodiments, as represented in the Figures, is not intended to limit the scope of the invention, as claimed, but is merely representative of various embodiments of the invention.

The word “exemplary” is used exclusively herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

The phrases “connected to” and “coupled to” refer to any form of interaction between two or more entities, including mechanical, electrical, magnetic, electromagnetic, fluid, and thermal interaction. Two components may be coupled to each other even though they are not in direct contact with each other.

The phrase “attached directly to” refers to a form of attachment by which the attached items are either in direct contact, or are only separated by a single fastener, adhesive, or other attachment mechanism. The term “abutting” refers to items that are in direct physical contact with each other, although the items may not necessarily be attached together.

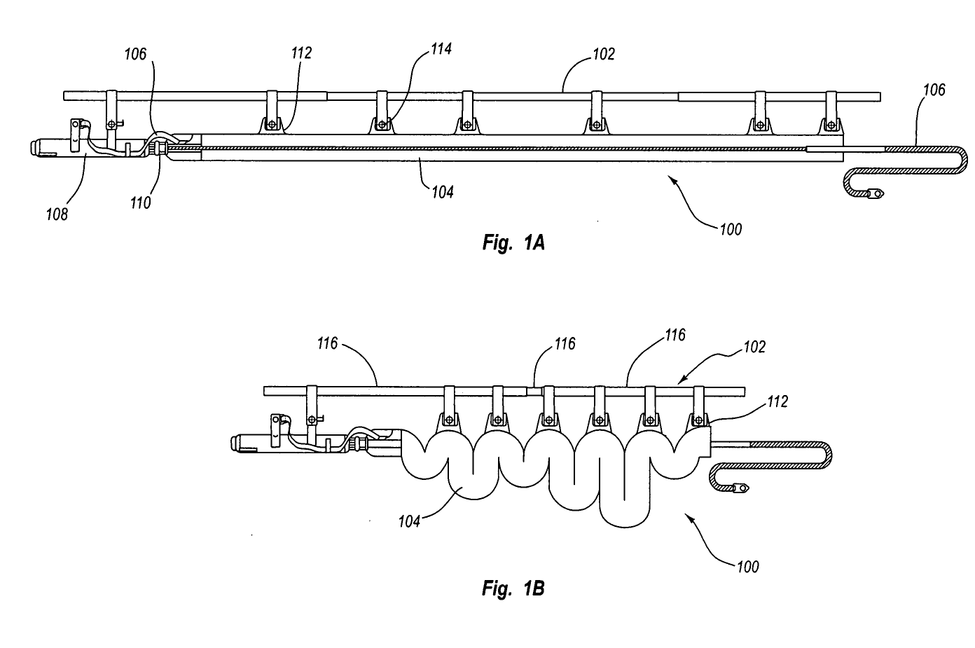

FIG. 1A is an undeployed inflatable curtain airbag assembly 100 coupled to a handling device 102 as illustrated from a side elevation view. The inflatable curtain airbag assembly 100 may include an inflatable curtain 104 that may be rolled, folded, or a combination of rolling and folding in an undeployed configuration. The inflatable curtain 104 may optionally be disposed in an envelope or sock. The airbag assembly 100 may also include a tethering system, which could include tethers 106. The tethering system may be an active pre-tensioning system such as a pyrotechnic pre-tensioner or similar device. Alternatively, the tethering system may be a passive tethering system. Additionally, the inflatable curtain assembly 100 may be able to deploy the inflatable curtain 104 without the aid of a tethering system.

The airbag assembly 100 may include an inflator 108 for providing inflation gas to rapidly deploy the inflatable curtain 104. The inflator 108 may be in fluid communication with the inflatable curtain 104 via a gas guide 110. Upon activation, the inflator 108 provides inflation gas to cushioning chambers (not shown) within the curtain 104 to provide impact protection from a lateral impact between a passenger and the side of a vehicle's interior.

The airbag assembly 100 also includes mounting locations 112 that are configured to be mounted to the interior of a vehicle, such as along a roof rail. The mounting locations 112 may be in the form of attachment tabs 112 which are attached directly to the vehicle via a fastener, or indirectly attached to the vehicle through a clip or similar mounting device. Alternatively, portions of an upper edge of the inflatable curtain 104 may serve as mounting locations 112 to be mounted and/or otherwise attached to the interior of the vehicle without the use of attachment tabs.

In its undeployed state, the inflatable curtain 104 is typically long and flexible, and configured to extend between the A and B pillars of a vehicle. Alternatively, the inflatable curtain 104 may be configured to extend between the A and C pillars or A and D pillars of a vehicle or some other configuration known to those having skill in the art.

According to the embodiment represented in FIG. 1A, the handling device 102 is located outside the cushioning chambers of the inflatable curtain 104, adjacent the mounting locations 112 of the airbag assembly 100. The handling device 102 may be adjacent two or more mounting locations 112 to prevent twisting there between. The handling device 102 may extend the length of all the mounting locations 112 along the inflatable curtain 104, or may be an alternative length as desired. In some embodiments the handling device 102 may engage a gas guide for delivering inflation gas to the inflatable curtain 104. However, in the embodiments depicted in the Figures, the handling device 102 is not coupled to or otherwise engaged with the gas guide.

The handling device 102 may engage the attachment tabs 112 or mounting locations of the airbag assembly 100 via a permanent or removable fastener 114. The various types of fasteners 114 that may be employed will be described in greater detail in conjunction with FIGS. 4A and 4B. Other methods of engagement between the handling device 102 and the attachment tabs 112 also could be used. Furthermore, alternative embodiments may include a configuration where the handling device 102 is not engaged with the mounting locations 112, but could be otherwise positioned adjacent the mounting locations 112.

The handling device 102 depicted in FIG. 1A has a rigidity or stiffness greater than that of the inflatable curtain 104. Since the handling device 102 is more rigid than the inflatable curtain 104, it may appropriately be referred to as a stiffening member 102. The handling device 102 helps to hold the inflatable curtain 104 in a relatively rigid or stable position, compared to the rigidity of the inflatable curtain 104 by itself, since typical inflatable curtains 104 have no similar means of support during shipping, handling, or installation.

For example, during installation of the inflatable curtain 104 into a vehicle, the handling device 102 may be engaged with a plurality of attachment tabs 112 of the inflatable curtain 104. The handling device 102 allows an airbag installer to hold the typically long, flexible inflatable curtain 104 in a steady position while it is installed into the vehicle. The attachment tabs 112 may then be more easily aligned with the mounting holes on the vehicle mounting location. When engaged with a plurality of attachment tabs 112, the handling device 102 also prevents twisting of the inflatable curtain 104 between attachment tabs 112. Furthermore, the handling device 102 may also reduce the number of people needed to install the inflatable curtain 104 into the vehicle.

Once the inflatable curtain 104 is installed, the handling device 102 may be removed from the inflatable curtain 104. This could be facilitated by the use of quick-release fasteners or some other form of removable fastener. Alternatively, the handling device 102 may be configured to remain with the inflatable curtain 104 once installed in the vehicle. A permanent fastener may be used in such situations.

FIG. 1B illustrates the undeployed curtain airbag assembly 100 coupled to the handling device 102 of FIG. 1A. The handling device 102 is illustrated in a compacted configuration having a length shorter than the length of the handling device of FIG. 1A. According to the embodiment depicted in FIG. 1B, the handling member 102 has telescoping portions 116. Alternatively, the handling member 102 could be one continuous piece, or have multiple portions that are optionally interconnected with joints.

Some of the telescoping portions 116 of the handling device 102 depicted in FIG. 1B are concentric with each other, and may have slightly differing cross-sectional diameters so that one telescoping portion 116 may be slidably received inside another telescoping portion 116. The telescoping portions 116 not only shorten or extend the length of the handling member 102 as desired, but also cause the undeployed inflatable curtain 104 to be in a more compacted or extended configuration. Hence the overall length of the curtain airbag assembly 100 may be reduced which aids in shipping and pre-installation handling. Even in a compacted configuration, the handling device 102 may still prevent the inflatable curtain 104 from being twisted between mounting locations 112.

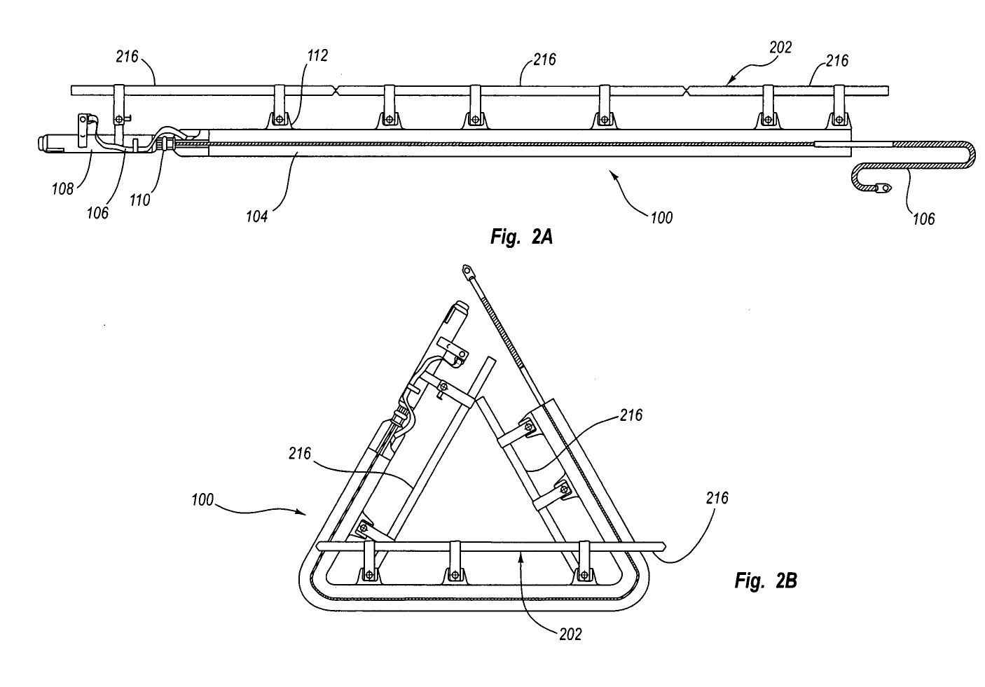

FIG. 2A is an undeployed inflatable curtain airbag assembly 100 coupled to an alternative embodiment of a handling device 202 as illustrated from a side elevation view. As with FIG. 1A, the inflatable curtain airbag assembly 100 may include an inflatable curtain 104, tethers 106, an inflator 108, and a gas guide 110 interconnecting the inflator 108 and the inflatable curtain 104.

The handling member 202 may be located outside the inflatable curtain 104, adjacent the mounting locations 112 of the airbag assembly 100. The handling device 202 may engage the mounting locations 112 and prevent twisting of the inflatable curtain 104 between mounting locations 112. The handling device 202 extends across the length of all the mounting locations 112 along the inflatable curtain 104, or may be longer or shorter as desired.

As with the handling device described in conjunction with FIG. 1A and 1B, the handling device 202 of FIG. 2A has a stiffness greater than that of the inflatable curtain 104, thereby helping to hold at least a portion of the inflatable curtain 104 in a relatively rigid or stable position, for example during installation.

Referring to FIGS. 2A and 2B, the handling device 202 may include multiple folding portions 216 that allow the curtain airbag assembly 100 to be situated in a compacted configuration (as shown in FIG. 2B), thereby shortening the overall length of the airbag assembly 100 which may aid in shipping and pre-installation handling. The folding portions 216 may be interconnected through mechanical joints that permit folding, such as a clevis pin, a spring loaded mechanism, or any other mechanism that allows the joint between folding portions 216 to remain in a straight or folded position.

When the folding portions 216 of the handling device 202 are in a straight configuration (as shown in FIG. 2A), the folding portions are arranged in a basically linear configuration relative to each other. In its folded configuration, the folding portions 216 of the handling device 202 may be arranged in a non-linear orientation with respect to each other (as shown by example in FIG. 2B).

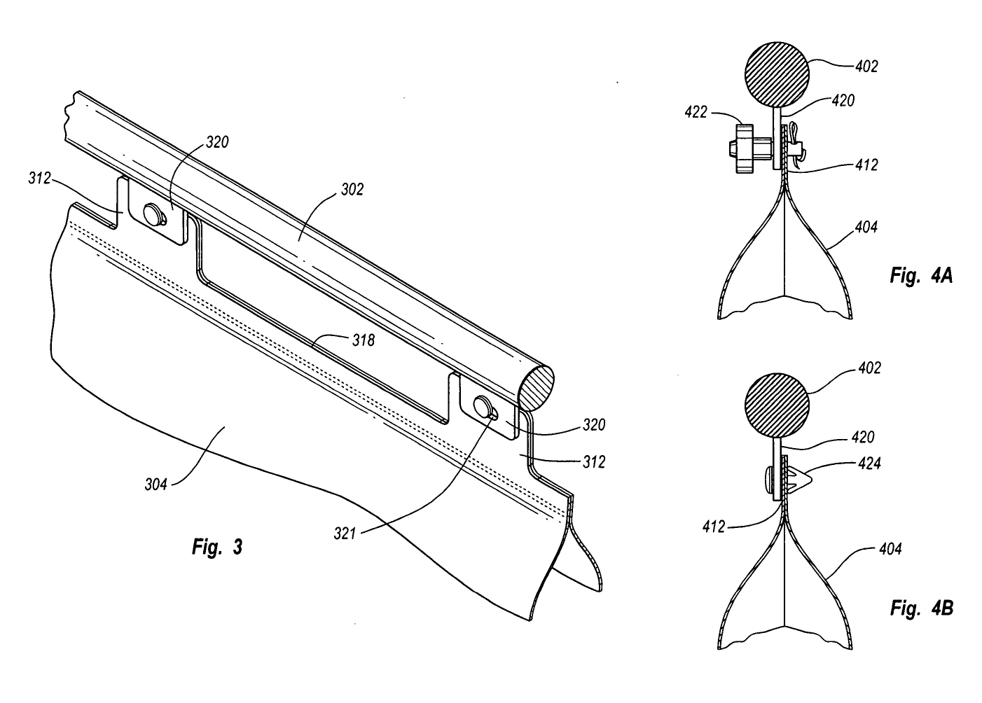

FIG. 3 depicts a handling device 302 coupled to an inflatable curtain 304 from a partially cut-away perspective view. The handling member 302 shown is engaged with the attachment tabs 312 located along an upper edge 318 of the inflatable curtain 304. The handling member 302 is a twist prevention device that prevents twisting of the inflatable curtain between the attachment tabs 312. The handling member 302 may accomplish this function by being more rigid, or being capable of becoming more rigid than the inflatable curtain 304.

The handling device 302 may include attachment clips or flaps 320 that abut or are otherwise disposed adjacent the attachment tabs 312 of the inflatable curtain 304. The attachment flaps 320 of the handling device 302 may have an aperture 321 that may be aligned with the mounting holes (not shown) of the attachment tabs 312 of the inflatable curtain 304 to receive a fastener there through. The handling device 302 may be in a substantially straight configuration, or may also be contoured to the upper edge 318 of the inflatable curtain 304.

The handling device 302 may be a single continuous piece having a stiffness greater than the stiffness of the inflatable curtain 304 when undeployed. Alternatively, the handling device 302 may comprise multiple portions or telescoping portions as heretofore described by way of example. Alternatively, the handling device 302 may be an inflatable tube that is separately inflatable from the inflatable curtain 304. An inflatable tube would become more rigid than the undeployed curtain 304 if sufficient air pressure is applied therein. Consequently, if the handling device 302 is an inflatable chamber, then it is capable of becoming more rigid than the undeployed curtain 304, thereby facilitating handling during installation and preventing twisting of the curtain 304 between attachment tabs 312.

FIGS. 4A and 4B represent a handling device 402 coupled to an inflatable curtain airbag 404 as depicted from a cross-sectional side elevation view. The handling device 402 may include an attachment flap 420 that extends from a body of the handling device 402 to abut or be disposed adjacent the attachment tabs 412 of the inflatable curtain 404. A fastener may be used to attach the handling device 402 to the inflatable curtain 404.

According to the embodiment shown in FIG. 4A, a removable fastener such as a clevis pin 422 may engage the attachment flaps 420 of the handling device 402 and the attachment tabs 412 of the inflatable curtain 404. According to the embodiment shown in FIG. 4B, a quick release fastener 424 may also be used to engage the handling device 402 and the inflatable curtain 404. These fasteners 422, 424 are removable, and would allow the handling device 402 to become disengaged with the inflatable curtain 404 once removed, for example, when the inflatable curtain 404 is installed within a vehicle. Other forms of releasable fasteners could also be used as apparent to one having skill in the art, such as a fastex fastener, a hook and loop fastener, or the like. Moreover, permanent fasteners may also be used if it is desirable for the handling device 402 to remain engaged with the inflatable curtain 404 after installation in the vehicle.

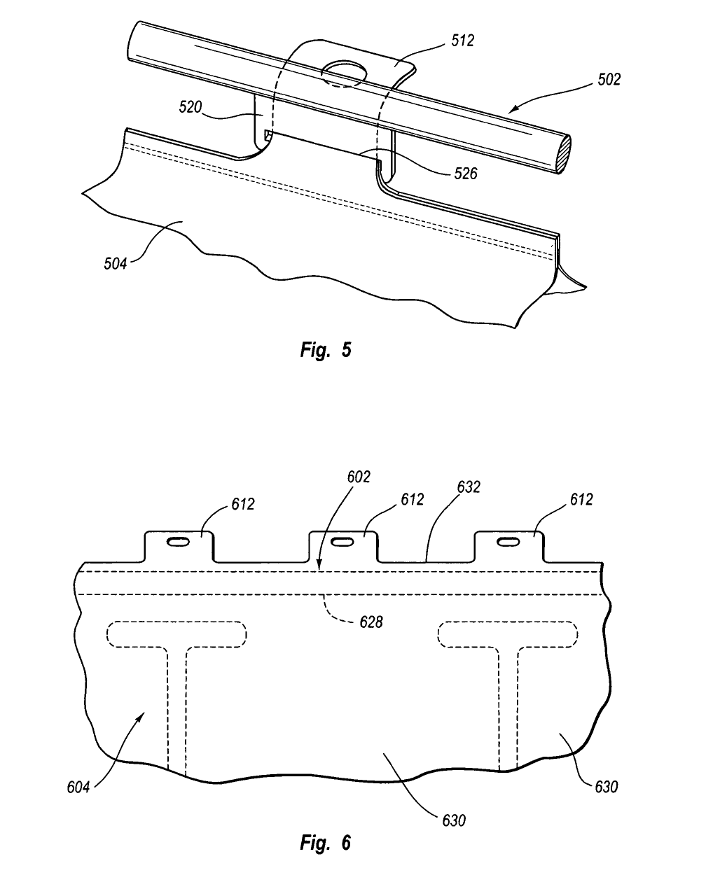

FIG. 5 illustrates an alternative embodiment of a handling device 502 that is slidably engaged to a mounting location 512 or attachment tab 512 of an inflatable curtain 504 as depicted from a partially cut-away perspective view. Instead of engaging the inflatable curtain 504 through the use of a fastener, this embodiment of the handling device 502 slidably engages the attachment tabs 512 through a receiving channel 526 disposed in the attachment flap 520 of the handling device 502. The handling device 502 may slidably engage multiple attachment tabs 512 of the inflatable curtain 504, which prevents twisting of the inflatable curtain 504 between attachment tabs 512.

Referring to FIG. 6, an alternative embodiment of a twist prevention device 602 of an inflatable curtain 604 is depicted from a partially cut-away side elevation view. The twist prevention device 602 is a separately inflatable twist prevention chamber 628 that extends adjacent a plurality of mounting locations 612 of the inflatable curtain 604. The twist prevention chamber 628 may be in a substantially straight configuration, or may also be contoured to an upper edge 618 of the inflatable curtain 604.

The twist prevention chamber 628 is separately inflatable from the cushioning chamber 630 of the inflatable curtain 604, in that the two chambers 628, 630 are not in fluid communication with each other. The cushioning chamber 630 of the inflatable curtain 604 is inflated by the inflator described in conjunction with FIG. 1A. The twist prevention chamber 628 may be inflated by another source, such as shop air or some other source of gas or other fluid.

When the twist prevention chamber 628 is inflated, it becomes more rigid than the material of the undeployed inflatable curtain 604. Consequently, the inflated twist prevention chamber 628 causes the inflatable curtain 604 to be in a relatively rigid or stable position, for mounting the airbag assembly into the vehicle. Moreover, the relative rigidity of the inflated twist prevention chamber 628 prevents twisting of the inflatable curtain 604 between mounting locations 612. After the inflatable curtain 604 is installed into the vehicle, the twist prevention chamber 628 may be deflated because the curtain 604 has been mounted in its proper orientation. Furthermore, deflating the twist prevention chamber 628 after installation also helps to minimize the volume the undeployed inflatable curtain 604 occupies in the area behind the headliner adjacent the roof rail of the vehicle.

According to the embodiment depicted in FIG. 6, the twist prevention chamber 628 is integrated into the material of the inflatable curtain 604. This could be accomplished through one-piece weaving technology or an alternative method as known to those having skill in the art. Alternatively, the twist prevention chamber 628 may be sewn onto or otherwise attached to the inflatable curtain 604, thereby remaining with the inflatable curtain 604 once installed within the vehicle. The twist prevention chamber 628 may also be a separate piece that is coupled to the inflatable curtain 604 by any fastening method and then removed and returned with the airbag assembly dunnage.

The airbags disclosed herein are examples of means for cushioning a vehicular occupant from an interior of a vehicle during a collision event. Furthermore, the mounting locations disclosed are examples of means for mounting the cushioning means to a vehicle. The attachment tabs disclosed are also examples of means for mounting the cushioning means to a vehicle.

The handling members, handling devices, twist prevention devices, stiffening members, and twist prevention chambers disclosed are all examples of handling means for preventing twisting of the cushioning means between mounting means during installation. Furthermore, the handling members, handling devices, stiffening members and twist prevention devices disclosed herein are all examples of stiffening means for preventing twisting between mounting means by being more rigid than the cushioning means. Moreover, the twist prevention chambers disclosed are examples of means for inflating alongside the mounting means to prevent twisting of the cushioning means between mounting means.

Without further elaboration, it is believed that one skilled in the art can use the preceding description to utilize the invention to its fullest extent. The examples and embodiments disclosed herein are to be construed as merely illustrative and not a limitation of the scope of the present invention in any way. It will be apparent to those having skill in the art that changes may be made to the details of the above-described embodiments without departing from the underlying principles of the invention. In other words, various modifications and improvements of the embodiments specifically disclosed in the description above are within the scope of the appended claims. Note that elements recited in means-plus-function format are intended to be construed in accordance with 35 U.S.C. § 112 ¶6. The scope of the invention is therefore defined by the following claims.

1. An airbag handling device, comprising:
a handling member positionable adjacent mounting locations on an inflatable curtain, the handling member having a stiffness greater than the inflatable curtain, such that the handling member is configured to aid in positioning the inflatable curtain during installation within a vehicle.

2. The handling device of claim 1, wherein the handling member is collapsible.

3. The handling device of claim 1, wherein the mounting locations are attachment tabs and the handling member is configured to engage the attachment tabs of the inflatable curtain.

4. The handling device of claim 3, wherein the handling member prevents twisting of the inflatable curtain between attachment tabs during installation of the inflatable curtain within the vehicle.

5. The handling device of claim 3, wherein the handling member is slidably engageable with the attachment tabs of the inflatable curtain.

6. The handling device of claim 1, wherein the handling member is configured to be located outside of the inflatable curtain.

7. The handling device of claim 1, wherein the handling member is removably attachable to the inflatable curtain, such that the handling member is removable after the inflatable curtain is installed in a vehicle.

8. The handling device of claim 7, further comprising a releasable fastener for attaching the handling member to the inflatable curtain.

9. The handling device of claim 1, wherein the handling member is permanently affixable to the inflatable curtain, such that the handling member remains affixed to the inflatable curtain after the inflatable curtain is installed in the vehicle.

10. The handling device of claim 2, wherein the handling member comprises an elongated member having a length sufficient to span a plurality of mounting locations on the inflatable curtain.

11. The handling device of claim 10, wherein the elongated member is comprised of multiple portions arrangeable in a non-linear orientation with respect to each other.

12. The handling device of claim 10, wherein the elongated member has telescoping portions such that the length of the elongated member is variable.

13. An airbag assembly, comprising:
an inflatable cushion having mounting locations disposed thereon, the mounting locations configured to be mounted to a vehicle; and
a twist prevention device that extends adjacent a plurality of the mounting locations to prevent twisting of the inflatable cushion between mounting locations during installation of the inflatable cushion within the vehicle.

14. The airbag assembly of claim 13, wherein the inflatable cushion is an inflatable curtain configured to provide impact protection along a side of the vehicle.

15. The airbag assembly of claim 14, wherein the twist prevention device is contoured to an upper edge of the inflatable curtain.

16. The airbag assembly of claim 14, wherein the twist prevention device is an inflatable twist prevention device.

17. The airbag assembly of claim 16, wherein the twist prevention device is an inflatable chamber, inflatable separate from a cushioning chamber of the inflatable curtain, the inflatable chamber configured to prevent twisting of the inflatable curtain when the inflatable chamber is inflated.

18. The airbag assembly of claim 17, wherein the inflatable chamber is integrated into a fabric of the inflatable curtain.

19. The airbag assembly of claim 17, wherein the inflatable chamber is fixedly attached to the inflatable curtain.

20. The airbag assembly of claim 17, wherein the inflatable chamber is removably coupled to the inflatable curtain.

21. The airbag assembly of claim 14, wherein the twist prevention device is a mechanical component engaged with the plurality of mounting locations.

22. The airbag assembly of claim 14, wherein the twist prevention device is a stiffening member having a stiffness greater than the inflatable curtain.

23. The airbag assembly of claim 22, wherein the stiffening member is engaged with the mounting locations of the inflatable curtain.

24. The airbag assembly of claim 22, wherein the stiffening member is located outside of the inflatable curtain.

25. The airbag assembly of claim 22, wherein the stiffening member is comprised of multiple portions arrangeable in a non-linear orientation with respect to each other.

26. The airbag assembly of claim 22, wherein the stiffening member has telescoping portions such that a length of the stiffening member is adjustable.
